(19) United States
(12) Patent Application Publication
(10) Pub. No.: US 2009/0095701 A1
(43) Pub. Date: Apr. 16, 2009

(54) Pouch Bottle

(75) Inventor: Jochen Forsthovel, Regensburg (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: KRONES AG, Neutraubling (DE)

(21) Appl. No.: 12/250,877

(22) Filed: Oct. 14, 2008

(30) Foreign Application Priority Data
Oct. 16, 2007 (DE) 102007049750.6

(51) Int. Cl. B65D 41/04; B65D 90/02; B23P 17/00

(52) U.S. Cl. 215/329; 215/384; 29/592

(57) ABSTRACT

A bottle that has at least one thinnest portion in which the wall thickness of the bottle is less than 0.1 mm and preferably less than 0.05 mm, and a method for producing such a bottle.

### CROSS-REFERENCE TO RELATED APPLICATION

The present application claims the benefit of priority of German Patent Application No. 102007049750.6, filed Oct. 16, 2007. The entire text of the priority application is incorporated herein by reference in its entirety.

### FIELD OF THE DISCLOSURE

The present disclosure relates to bottles having a low dead weight and to a method for producing such bottles.

With beverage packages the weight of the package and the material consumption, respectively, are decisive factors in the making of packages. Especially with disposable packaging attention must be paid to low material consumption so as to save raw materials and costs.

One possibility of keeping the material consumption small consists in packing beverages in bags. This, however, has the drawback that both in their empty and in their filled state the bags are not dimensionally stable. This may e.g. have the effect that when a beverage bag is gripped its contents will get discharged inadvertently.

By contrast, bottles, such as glass bottles, are dimensionally stable, i.e. an unintended compressing of the bottle is not possible or only possible with great difficulty. However, even in their empty state, glass bottles are relatively heavy.

It is possible by selecting suitable materials for producing the bottle, for instance PET plastics (“PET” is the abbreviation for “polyethylene terephthalate”), PLA, PP (“polypropylene”), PS (“polystyrene”) or PEN (“polyethylene naphthalate”) to considerably reduce the weight of the bottles in comparison with glass bottles. It is known from the prior art that the PET bottles can be produced with a relatively low dead weight; the wall thickness, however, is here in general the same over the substantial area of the bottles (with the exception of the mouth area).

### SUMMARY OF THE DISCLOSURE

It is the object of the present disclosure to further reduce the weight of bottles and the material consumption, respectively, in bottle production.

A bottle according to the disclosure is distinguished in one embodiment in that the bottle has at least one thinnest portion in which the wall thickness of the bottle is only 0.1 mm at the most and preferably 0.05 mm at the most. With these features a bottle according to the disclosure comprises at least one very thin portion for which only little material is needed during manufacture, resulting in the advantage stated for the invention.

Although such a bottle can be compressed easily in the thin portion, the bottle, nevertheless, shows adequate dimensional stability. Therefore, in this context the bottle comprises a grip portion in a preferred embodiment of the disclosure. The grip portion is typically characterized in that the bottle can be held in this portion. For example, the grip portion may be provided with structures preventing the bottle from slipping out of the hand. Preferably, the circumference of the grip portion is chosen such that the bottle can be comfortably gripped with one hand.

Under another aspect of the disclosure the bottle has a volume portion forming the largest circumference of the bottle, and a grip portion having a circumference smaller than the circumference of the largest circumference of the volume portion. The bottle according to the disclosure has a ratio of the volume portion circumference to the grip portion circumference of more than 1.4. A further optional aspect of this embodiment of the disclosure is that the wall thickness of the bottle in the thinnest portion is not more than 0.1 mm, preferably not more than 0.05 mm. The thinnest portion is typically the portion having the largest circumference.

In a preferred embodiment of the disclosure the bottle is a PET bottle. Furthermore, a bottle of this disclosure typically has a volume or liquid holding capacity of 0.5 1. Depending on the use, this volume, however, may also be larger. This, however, requires a corresponding adaptation of the wall thicknesses of the bottle.

A bottle according to the disclosure may have multiple shapes; for instance, the cross-section may be round, square or polygonal with optionally rounded or non-rounded corners.

Advantageously, the wall thickness of the bottles at places of a larger circumference is typically smaller than at places of a smaller circumference. This has the consequence that such a bottle is typically provided in the area of the bottle mouth and in the grip portion with a larger wall thickness and thus shows a greater stability than in the area with the largest circumference. Depending on the type of bottle filling, an additional reinforcement may be provided in the area of the bottle bottom.

In a preferred embodiment of the disclosure the bottle is configured with such a bottle bottom that the bottle can be put in an upright position. The bottle bottom may e.g. be a champagne bottom (or still water bottom) with or without reinforcement or a petaloid bottom. The selection of the bottle bottom depends mainly on the use of the bottle.

In a further embodiment of the disclosure the grip portion of the bottle is provided with reinforcement structures, such as grooves or spirals. Furthermore, the reinforcement structures can prevent a situation where the bottle while being held tends to slip out of the hand. In a preferred embodiment of the present disclosure the grip portion is spaced apart from the bottle cap thread by at least 1 cm. Preferably, the circumference of the bottles in the grip portion should be substantially uniform (apart from the grooves or spirals). In a typical embodiment of the disclosure the share of the grip portion volume in the total volume of the bottle is about 20%. To be able to use the bottle volume more efficiently, the grip portion in the filled state of the bottle is filled with liquid in part or fully in a preferred embodiment.

Preferably, the bottle of this disclosure is filled with still water or juice. Other fillings, however, for example carbonated beverages or beverages pressurized with nitrogen, are also possible.

In a preferred embodiment of the present disclosure, the bottle in the filled or unfilled state is dimensionally stable, i.e. the bottle keeps its original shape on condition that the bottle is not exposed to additional forces (arising e.g. upon squeezing of a bottle). This dimensional stability is also of benefit when bottles are to be stacked and stored, respectively, in bottle containers. In a preferred embodiment of the present disclosure, the bottles are arranged in a space-saving way in a bottle container such that the bottle mouths are alternatingly oriented upwards and downwards or to the left and to the right or to the rear and to the front.

The method for producing a bottle comprises a blow molding method which upon expansion of the bottle material shows a maximal area stretching of more than 20 according to the disclosure. In further possible embodiments of the disclosure the bottles produced in this way have the same or at least similar properties, as has been described above.

### BRIEF DESCRIPTION OF THE DRAWINGS

Further aspects of possible embodiments of the disclosure shall be illustrated with reference to the figures, in which:

FIG. 1a is a schematic view of a bottle according to a first possible embodiment of the disclosure;

FIG. 1b is a schematic view of a bottle according to a second possible embodiment of the disclosure;

FIG. 2a is a schematic view of a champagne bottom;

FIG. 2b is a schematic view of a petaloid bottom;

FIG. 3 is a schematic view of a bottle container;

FIG. 4 shows the workflow of a blow molding method.

### DETAILED DESCRIPTION OF THE PREFERRED EMBODIMENT

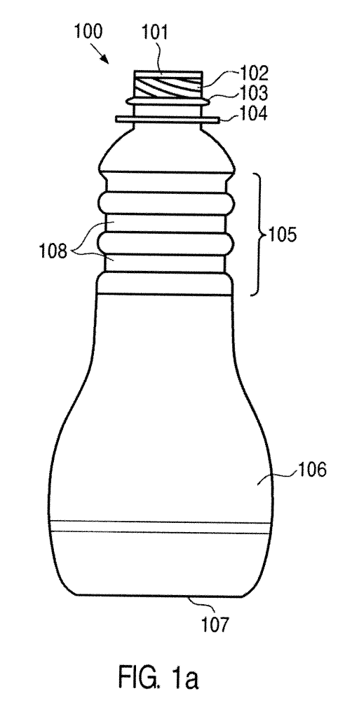

FIG. 1a shows a first possible embodiment of the bottle 100 according to the disclosure. Typically, the bottle mouth is positioned in the upper part of the bottle and, next thereto, an optional thread 102 if a screw cap is intended for the bottle, a securing ring 103 and a supporting ring 104. The securing ring 103 and the supporting ring 104 are mainly of importance in the handling of the bottle by machinery. As a rule, one clamp gripping the bottle alternates with the next clamp between the supporting ring 104 and the securing ring 103, with one clamp gripping below the supporting ring 104 and a further clamp gripping above said supporting ring 104. As an alternative, however, there are also bottles that have no supporting ring 104 or only one of a rudimentary shape. In cases where a supporting ring 104 is missing, the securing ring 103 is used as such.

Typically, the grip portion 105 is positioned underneath the supporting ring 104. This portion is particularly suited for gripping the bottle in everyday use (with a hand). This is facilitated in the case of FIG. 1a with the help of grooves 108. The areas above and below the grip portion 105 are preferably used for labeling the bottle. The volume portion 106 of the bottle is above all distinguished by the feature that a large part of the bottle filling is contained in this portion. Therefore, the portion with the largest circumference typically forms part of the volume portion 106. The optional bottle bottom 107 makes it possible to put the bottle in an upright position.

A further possible embodiment of the bottle 100 according to the disclosure is sketched in FIG. 1b. This bottle 100 comprises similar elements, but the grip portion 105 is stabilized with the help of spirals 109, which in addition provides for an improved gripping of the bottle. Moreover, in this example the share of the grip portion volume in the total volume of the bottle is smaller than in the example of FIG. 1a.

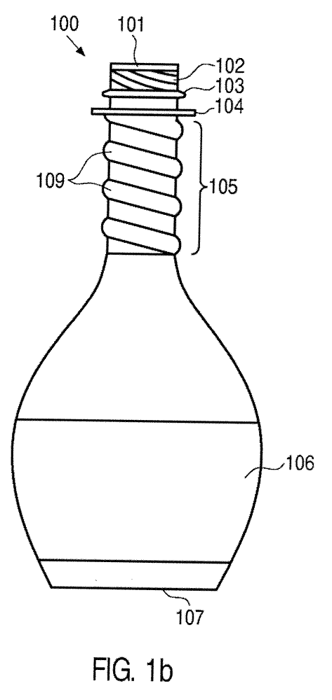

Possible bottle bottoms 107 are explained with reference to FIGS. 2a and 2b. Depending on the application (e.g. the kind of bottle filling), a champagne bottom 201 or a petaloid bottom 202 is better suited. The advantage of the champagne bottom 201 is that at the same wall thickness less material is used than in the case of the petaloid bottom 202 because the champagne bottom 201 has a smaller surface. The petaloid bottom 202 has the advantage that it is very stable if the bottle is subjected to high pressure (e.g. if the bottle is filled with a carbonated beverage). Depending on the requirements, additional reinforcement elements may be used for both the champagne bottom 201 and the petaloid bottom 202.

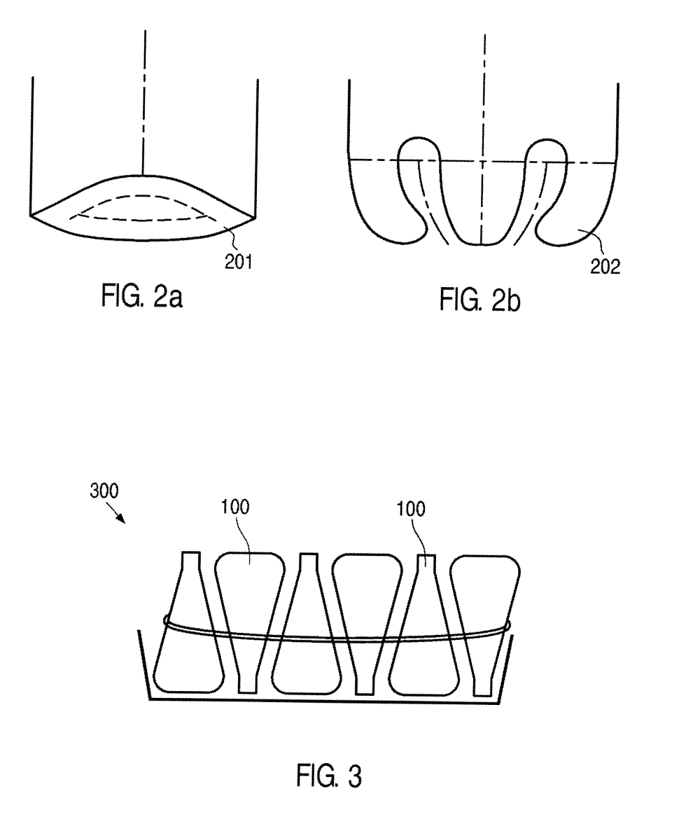

FIG. 3 shows a bottle container 300. In this example the bottles 100 are arranged side by side in alternating fashion with bottle neck opening upwards and with bottle neck opening downwards, whereby space-saving storage of the bottle is made possible. Furthermore, space can additionally be saved during stacking by selecting the bottle shape in an appropriate way.

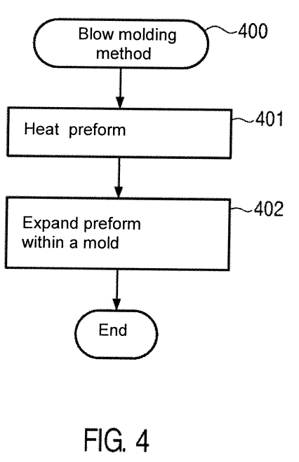

FIG. 4 explains a blow molding method 400. In step 401 a preform (bottle blank) is heated, whereby the preform becomes deformable. In step 402 the preform is expanded within a mold, for instance with the help of air pressure. Depending on the extent of expansion the bottle material is area-stretched by a factor of >20 (1 cm² of the preform is expanded to an area of more than 20 cm²). At the same time the wall thickness is decreasing during the area stretching operation. In the case of bottles 100 this means in general that with large-area stretching a correspondingly large bottle volume is obtained.

I claim:

1. A bottle, comprising
at least one thinnest portion in which the wall thickness of the bottle is less than 0.1 mm.

2. The bottle according to claim 1, wherein the bottle comprises a grip portion.

3. A bottle comprising:
a volume portion which forms the largest circumference of the bottle; and
a grip portion with a smaller circumference than that of the volume portion, and wherein
the ratio of the volume portion circumference to the grip portion circumference is greater than 1.4.

4. The bottle according to claim 1, wherein the bottle is a plastic bottle.

5. The bottle according to claim 1, wherein the bottle can contain one of 0.5, 0.75, 1.0, 1.25, 1.5, 1.75 or 2.0 liters of liquid.

6. The bottle according to claim 1, wherein the cross-section of the bottle is one of round, square and polygonal.

7. The bottle according to claim 3, wherein the wall thickness of the bottle is smaller in the volume portion then in the grip portion.

8. The bottle according to claim 1, wherein the bottle includes a bottle bottom for standing the bottle in an upright position.

9. The bottle according to claim 8, wherein the bottle bottom is one of a champagne bottom with reinforcement, a champagne bottom without reinforcement, a petaloid bottom, a still water bottom with reinforcement or a still water bottom without reinforcement.

10. The bottle according to claim 3, wherein the grip portion is provided with reinforcement structures.

11. The bottle according to claim 3, wherein the bottle has a bottle closing thread, and the grip portion is spaced apart from the area of the bottle closing thread (102) by one of at least 0.5, 1, 2, 3, 4 or 5 cm.

12. The bottle according to claim 3, wherein the grip portion has a substantially uniform circumference.

13. The bottle according to claim 3, wherein the share of the grip portion volume in the total volume of the bottle is within a range of one of at least 10%, 15%, 20%, 30% or 40%, and not more than one of 15%, 20%, 30%, 40% or 50%.

14. The bottle according to claim 3, wherein the grip portion in the filled state of the bottle is filled with liquid one of in part or fully.

15. The bottle according to claim 1, wherein the bottle can be filled with one of still water, juice, a carbonated beverage, a beverage pressurized with nitrogen, and combinatons thereof.

16. The bottle according to claim 1, wherein the bottle is dimensionally stable.

17. A bottle container with bottles according to claim 1, each of the bottles having a bottle mouth, wherein the bottles are arranged side by side with the bottle mouth alternating upwards and downwards.

18. A method for producing a bottle in a blow molding method, comprising stretching
a maximal area during expansion to be more than one of 15, 20, 25, 30, 35, 40, 45 or 50.

19. The method according to claim 18, wherein a PET bottle is produced.

20. The method according to claim 18, and producing the bottle to have a wall thickness which is smaller at places of a larger circumference than at places of a smaller circumference.

21. The method according to claim 18, and producing a bottle with one of a champagne bottom or a petaloid bottom.

22. The method according to claim 18, and producing a bottle with a grip portion which is provided with reinforcement structures which enables one of a holding and lifting of the bottle.

23. The method according to claim 18, and producing the bottle such that it is dimensionally stable.

24. The bottle of claim 1, wherein the wall thickness is less than 0.07 mm.

25. The bottle of claim 1, wherein the wall thickness is less than 0.05 mm.

26. The bottle of claim 3, wherein the ration is greater than 1.8.

27. The bottle of claim 3, wherein the ration is greater than 2.4.

28. The bottle of claim 4, wherein the plastic bottle is a PET bottle.

29. The bottle of claim 10, wherein the reinforcement structures are one of grooves and spirals.

30. The method according to claim 22, wherein the reinforcement structures are one of grooves and spirals.

31. The bottle of claim 6, wherein the cross-section of the bottle is one of square and polygonal and includes a plurality of rounded corners.

32. The bottle according to claim 3, wherein the bottle is a plastic bottle.

33. The bottle according to claim 3, wherein the cross-section of the bottle is one of round, square and polygonal.

34. The bottle according to claim 33, wherein the cross-section of the bottle is one of square and polygonal and includes a plurality of rounded corners.

35. The bottle according to claim 3, wherein the bottle includes a dimensionally stable bottle bottom for standing the bottle in an upright position.

36. The bottle according to claim 3, wherein the bottle bottom is one of a champagne bottom with reinforcement, a champagne bottom without reinforcement, or a petaloid bottom.

37. The bottle according to claim 3, having a wall thickness in the volume portion of less than 0.1 mm.

38. The bottle according to claim 3, having a wall thickness in the volume portion of less than 0.07 mm.

39. The bottle according to claim 3, having a wall thickness in the volume portion of less than 0.05 mm.

40. The bottle according to claim 1, wherein the circumference of the bottle varies along its length and wall thickness of the bottle is smaller at places of a larger circumference than at places of a smaller circumference.
